(19) United States
(12) Patent Application Publication
(10) Pub. No.: US 2015/0220512 A1
(43) Pub. Date: Aug. 6, 2015

(54) LANGUAGE INTERFACE SYSTEM, METHOD AND COMPUTER READABLE MEDIUM

(71) Applicant: Marco Álvarez Heinemeyer, Exeter, NH (US)

(72) Inventor: Marco Álvarez Heinemeyer, Exeter, NH (US)

(21) Appl. No.: 14/173,215

(22) Filed: Feb. 5, 2014

(51) Int. Cl. G06F 17/28; G10L 15/00; G10L 17/00; G10L 15/26

(52) U.S. Cl. CPC G06F 17/28; G10L 15/26; G10L 15/005; G10L 17/00

(57) ABSTRACT

A language interface system and method to be used, preferably, by the deaf, hearing impaired, mute persons or visually impaired is described. The language interface method is implemented through an electronic computer system/device which selects a setting mode, receives input in the form of language, audio or of an image, interprets the input as written language, spoken language or an identifiable physical object image depending on the setting mode, and produces an output depending on the setting mode. The setting mode is selected from a group of input/output modes comprising language mode, noise interpretation mode or visual interpretation model. The language interface method may be embodied and implemented in, but not limited to, mobile devices such as an Internet-enabled mobile phone, PDAs, tablet computers or wearable computers with an optical display embedded in glasses.

### BACKGROUND

The present invention refers to language communication systems and methods to be used by the deaf, hearing impaired, mute persons or visually impaired and other people in general, including handicapped and those not similarly handicapped.

Deaf, hearing impaired, mute persons or visually impaired people have always had great difficulties in communicating among themselves and with other people in general. With many communication advances available nowadays with the use of technology, these communication difficulties have been minimized but still the language communication problems in the handicapped community still prevail. In addition, the language communication systems found in the prior art directed to the handicapped community do not contemplate communication between users speaking different languages.

In U.S. Patent Publication No. 2007/0003025 A1, a system and method is disclosed making use of certain techniques that reduce the English language, written or spoken, to a formal text that can be distributed by electronic means and translated to American Sign Language. In U.S. Patent Publication No. 2007/0003025 A1, the reduced text is a metalanguage that can be conveyed, using distinct communication channels, to varied devices, including cell phones and digital assistants and presented in text, voice or animated ASL. Although not completed directed to tackling the communication difficulties encountered by the handicapped community, U.S. Pat. No. 8,032,384 B2 deals with a hand-held language translation device comprising a microprocessor configured to receive an audio input from a foreign speaker and a simultaneous visual input signal generated by a camera which captures the facial expression and body language of the foreign speaker, and further configured to translate the spoken foreign language into a written form in the language of the user which is stored and retrievable in the hand-held language translation device.

In order to overcome the difficulties and limitations found in the prior art, a language interface system and method to be used primarily by the deaf, hearing impaired, mute persons or visually impaired people has been devised.

### SUMMARY

According to the features of the present invention, a language interface system and method to be used, preferably, by the deaf, hearing impaired, mute persons or visually impaired is described. In a preferred embodiment of the present invention, the language interface system and method entails selecting a setting mode, receiving input in the form of language, audio or of an image, interpreting the input as written language, spoken language or an identifiable physical object image depending on the selected setting mode and producing an output depending on the selected setting mode. The setting mode is selected from a group of input/output modes comprising language mode, noise interpretation mode or visual interpretation model. The language interface system and method may be implemented in an electronic computer system/device that is embodied in, but not limited to, mobile devices such as an Internet-enabled mobile phone, PDAs, tablet computers or wearable computers with an optical display embedded in glasses.

In another embodiment of the present invention, the language mode of the selected input/output setting mode processes language as input in the form of voice via the electronic computer system's microphone or in the form of text from an image via the electronic computer system's camera. In the language mode of the selected input/output setting mode, a deaf, hearing impaired, or mute user may be able to select an input language and/or input format. Alternatively, the input language and/or input format may be automatically selected/configured in the case of a visually impaired user. In the language mode of the selected input/output setting mode, the electronic computer system may also automatically detect the input language automatically.

In yet another embodiment of the present invention, the language mode of the selected input/output setting model allows the electronic computer system to employ voice recognition to discern voices from 2 or more persons. In another embodiment of the present invention, the noise interpretation mode processes audio as input, the audio input being analyzed and interpreted as common urban sounds by the electronic device, and outputs the analyzed and interpreted audio input in the form of text or voice. In yet another embodiment of the present invention, the visual interpretation mode uses the electronic computer system's camera to interpret the nearest discernable object or person and outputs the nature or name of the nearest discernable object or person through voice or text depending on the output format mode setting selected.

### BRIEF DESCRIPTION OF THE DRAWINGS

FIG. 1 illustrates an embodiment of the settings flow of language interface methodology and system of the present invention.

FIG. 2 illustrates an embodiment of the voice input-text output flow of the language interface methodology and system of the present invention.

FIG. 3 illustrates an embodiment of the text input-text output flow of the language methodology and system of the present invention.

FIG. 4 illustrates an embodiment of the noise input-text output flow of the language methodology and system of the present invention.

FIG. 5 illustrates an embodiment of the voice input-output flow of the language interface methodology and system of the present invention.

FIG. 6 illustrates an embodiment of the image input-text output flow of the language interface methodology and system of the present invention.

### DETAILED DESCRIPTION

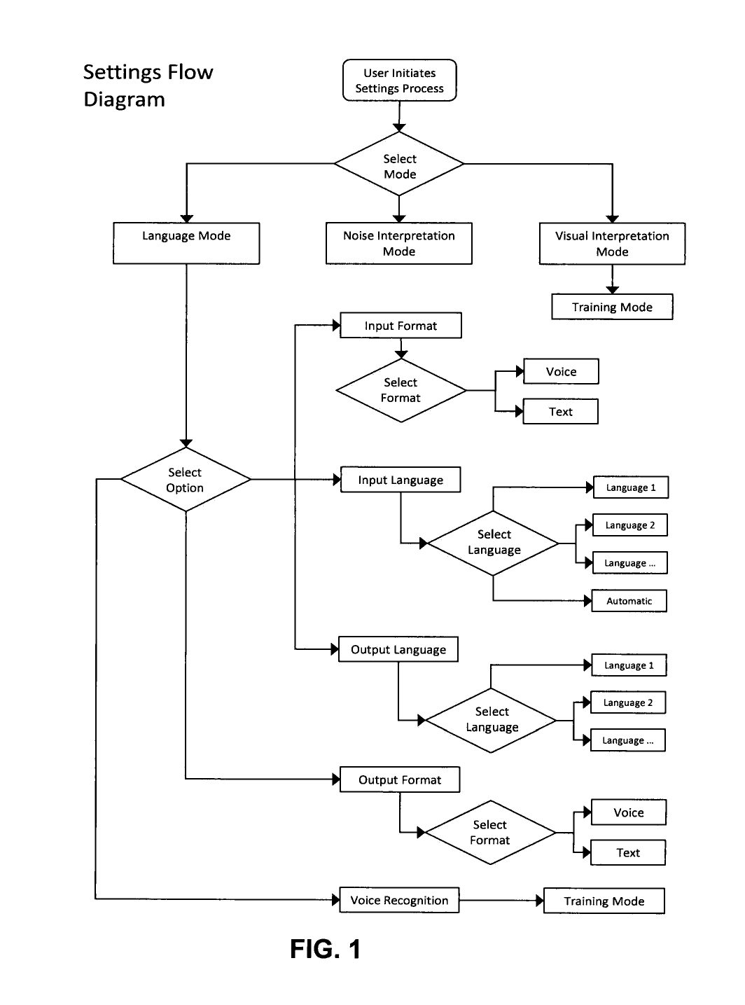

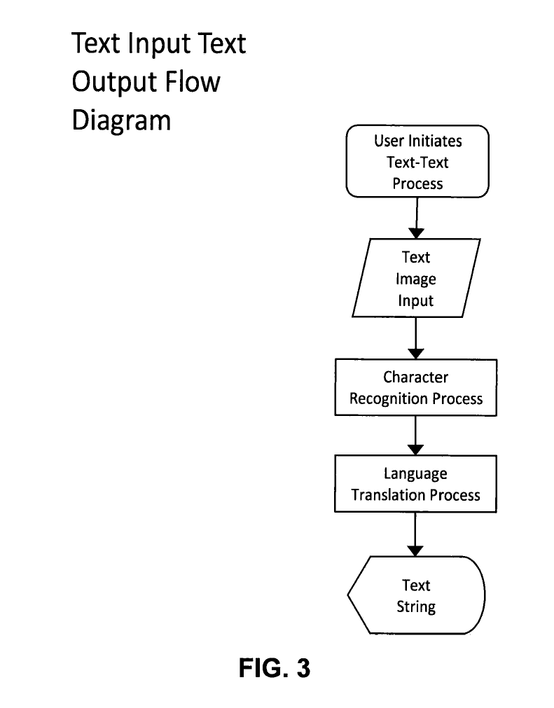

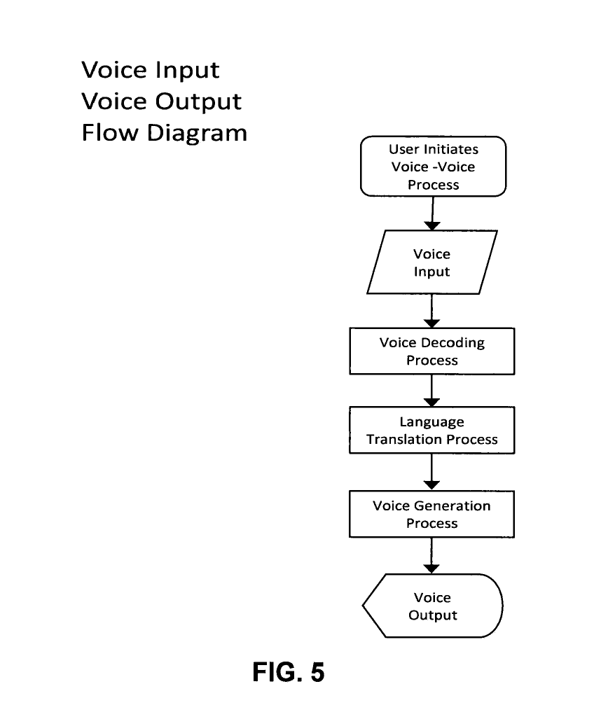

In a preferred embodiment of the computing environment and implementation of the inventive method of the present invention illustrated in FIGS. 1 through 6, the language interface method in which selection of an setting mode, the setting mode is selected from a group of input/output modes comprising language mode, noise interpretation mode or visual interpretation model, reception of input in the form of language, audio or of an image, interpretation of the input as written language, spoken language or an identifiable physical object image depending on the selected setting mode and production of an output depending on the selected setting mode, takes place. The language interface method may be implemented through an electronic computer system, the electronic computer system including a processing unit, a system memory and a system bus. The system bus couples system components including, but not limited to, the system memory to the processing unit. The processing unit can be any of various commercially available processors. Dual microprocessors and other multi-processor architectures may also be employed as the processing unit.

While the innovation of the present invention may be described in the general context of computer-executable instructions that may run on one or more computers, those skilled in the art will recognize that the innovation also can be implemented in combination with other program modules and/or as a combination of hardware and software. Generally, program modules include routines, programs, components, data structures, etc., that perform particular tasks or implement particular abstract data types. Moreover, those skilled in the art will appreciate that the inventive method can be practiced with other electronic computer system configurations, including single-processor or multiprocessor computer systems, minicomputers, mainframe computers, as well as personal computers, hand-held computing devices such as PDAs, microprocessor-based or programmable consumer electronics, and the like, each of which can be operatively coupled to one or more associated devices. Particularly, the inventive method may be embodied and implemented in, but not limited to, mobile devices such as an Internet-enabled mobile phone, PDAs, tablet computers or wearable computers with an optical display embedded in glasses.

The wearable computer with an optical display embedded in glasses in which the inventive method may be embodied and implemented may be Google Glass™. The inventive method may also be embodied and implemented in other electronic computer systems/devices having touch-sensitive input capabilities including one or more touch surfaces, one or more camera, one or more microphones, and one or more sensors such as, but not limited to, motion sensors, magnetometers, and accelerometers. The illustrated aspects of the innovation may also be practiced in distributed computing environments where certain tasks are performed by remote processing devices that are linked through a communications network. In a distributed computing environment, program modules can be located in both local and remote memory storage devices.

The electronic computer system in which the inventive method of the present invention may be implemented may typically include a variety of computer-readable media. Computer-readable media can be any available media that can be accessed by the computer system and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer system.

The inventive method of the present invention may be implemented through communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system bus can be any of several types of bus structure that may further interconnect to a memory bus (with or without a memory controller), a peripheral bus, and a local bus using any of a variety of commercially available bus architectures. The system memory includes read-only memory (ROM) and random access memory (RAM). A basic input/output system (BIOS) is stored in a non-volatile memory such as ROM, EPROM, EEPROM, which BIOS contains the basic routines that help to transfer information between elements within the electronic computer system, such as during start-up. The RAM can also include a high-speed RAM such as static RAM for caching data.

The electronic computer system further includes an internal hard disk drive (HDD) (e.g., EIDE, SATA), which internal hard disk drive may also be configured for external use in a suitable chassis (not shown), a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive can be connected to the system bus by a hard disk drive interface, a magnetic disk drive interface and an optical disk drive interface, respectively. The interface for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the electronic computer system, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by an electronic computer system, such as zip drives, magnetic cassettes, flash memory cards, cartridges, and the like, may also be used in the exemplary operating environment, and further, that any such media may contain computer-executable instructions for performing the method of the innovation.

A number of program modules can be stored in the drives and RAM, including an operating system, one or more application programs, other program modules and program data. All or portions of the operating system, applications, modules, and/or data can also be cached in the RAM. It is appreciated that the innovation can be implemented with various commercially available operating systems or combinations of operating systems.

A user can enter commands and information into the electronic computer system through one or more wired/wireless input devices, e.g., a keyboard and a pointing device, such as a mouse. Other input devices may include a microphone, an IR remote control, a joystick, a game pad, a stylus pen, touch screen, or the like. These and other input devices are often connected to the processing unit through an input device interface that is coupled to the system bus, but can be connected by other interfaces, such as a parallel port, an IEEE serial port, a game port, a USB port, an IR interface, etc.

A monitor or other type of display device is also connected to the system bus via an interface, such as a video adapter. In addition to the monitor, the electronic computer system may typically includes other peripheral output devices, such as speakers, printers, etc.

The electronic computer system may operate in a networked environment using logical connections via wired and/or wireless communications to one or more remote computers, such as a remote computer(s). The remote computer(s) can be a workstation, a server computer, a router, a personal computer, portable computer, microprocessor-based entertainment appliance, a peer device or other common network node, and typically includes many or all of the elements described relative to the electronic computer system including, but not limited to, a memory/storage device. The logical connections depicted include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, all of which may connect to a global communications network, e.g., the Internet.

When used in a LAN networking environment, the electronic computer is connected to the local network through a wired and/or wireless communication network interface or adapter. The adapter may facilitate wired or wireless communication to the LAN, which may also include a wireless access point disposed thereon for communicating with the wireless adapter.

When used in a WAN networking environment, the electronic computer system may include a modem, or is connected to a communications server on the WAN, or has other means for establishing communications over the WAN, such as by way of the Internet. The modem, which can be internal or external and a wired or wireless device, is connected to the system bus via the serial port interface. In a networked environment, program modules depicted relative to the electronic computer system, or portions thereof, can be stored in the remote memory/storage device. It will be appreciated that the network connections are exemplary and other means of establishing a communications link with and between the electronic computer systems can be used.

The electronic computer system may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™. wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

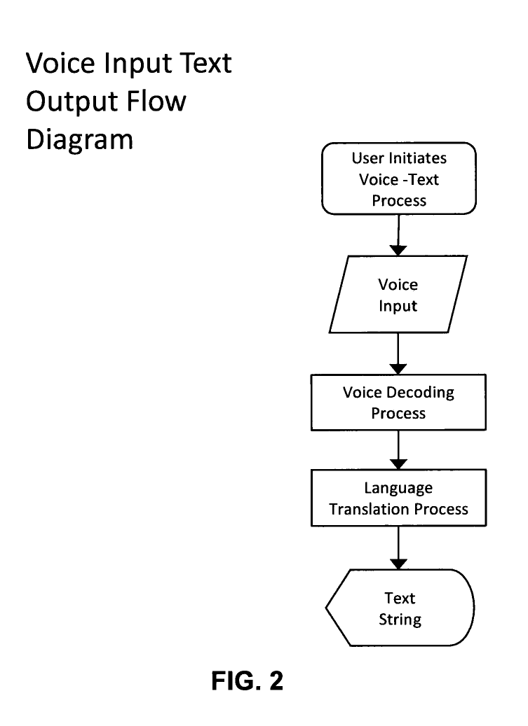

In a preferred embodiment of the present invention, the language mode of the selected input/output setting mode, as illustrated in FIGS. 2, 3, 5 and 6, processes language as input in the form of voice via the electronic computer system's microphone or in the form of text from an image via the electronic computer system's camera. In the language mode of the selected input/output setting mode, a deaf, hearing impaired, or mute user may be able to select an input language and/or input format. Alternatively, the input language and/or input format may be automatically selected/configured in the case of a visually impaired user. In the language mode of the selected input/output setting mode, the electronic computer system may also automatically detect the input language automatically. In this particular settings, the user initiates the voice-to-text, text-to-text or voice-to-voice processes by having the voice input or text image input being processed, the voice input being decoded or the text image input being optically recognized as character text, the decoded voice or the optically recognized character text being properly translated and output as text string or generated voice.

In yet another preferred embodiment of the present invention, the language mode of the selected input/output setting mode, as illustrated in FIGS. 2, 3, 5 and 6, outputs language in the form of text, typically delivered to the electronic computer system's display, or voice typically delivered via spoken language through the electronic computer system's speakers. In the language mode of the selected input/output setting mode, a deaf, hearing impaired, or mute user may be able to select an output language and/or output format. Alternatively, the output language and/or output format may be automatically selected/configured in the case of a visually impaired user.

In the particular settings, the user initiates the voice-to-text or text-to-text processes by having the voice input or text image input being processed, the voice being decoded or the text image being optically recognized by character, the decoded voice or the optically recognized character text being properly translated and output as text string. In a preferred embodiment of the present invention, any number of translation electronic platforms may be employed to undertake the task of translating voice and/or text input into voice and/or text output including, but not limited to, the widely used Google Translator, Bing Translator; Babel Fish, among others.

In another preferred embodiment of the present invention, the language mode of the selected input/output setting model allows the electronic computer system to employ voice recognition to discern voices from 2 or more persons. This particular functionality found in the language mode is made possible through a training mode in which the user can identify a speaker, for example, through the audio command “add speaker”. In said particular language mode, the electronic computer system identifies characteristics of the speaker's voice. The user is allowed to add additional speakers through the same process. Furthermore, output from different speakers are differentiated with a distinct color text presented on the electronic computer system's display when the output mode is “text”. In addition, when the output mode is “voice”, the electronic computer system's output spoken language identify speakers with numbers. For example, the electronic computer system says “Speaker 1” before broadcasting what Speaker 1 says.

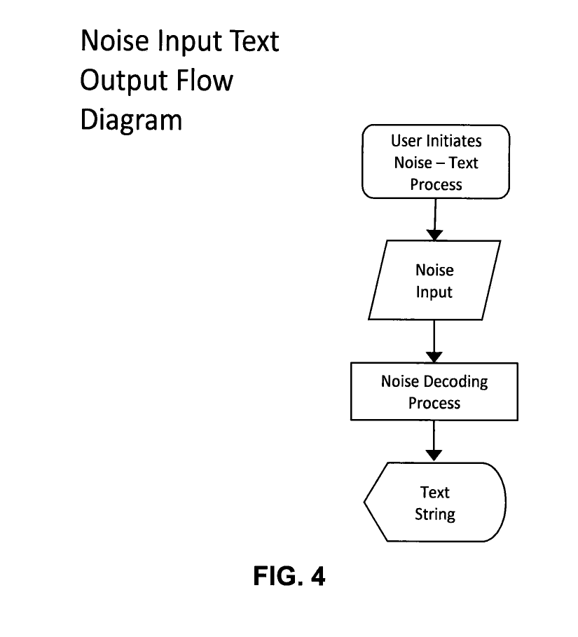

In another embodiment of the present invention, the noise interpretation mode, as illustrated in FIG. 4, processes audio as input, the audio input being analyzed and interpreted as common urban sounds by the electronic device, and outputs the analyzed and interpreted audio input in the form of text or voice. In the noise interpretation mode, all types of audio are accepted as input. Sounds such as dog barks or car honks output text strings such as “dog barks” or “car honks”. If the electronic computer system, such as a wearable device, has a microphone on each side, the electronic computer system will inform the user of the direction of the sound. For example, String:“car honk or →” or “←dog barks”. In the particular settings, the user initiates the noise-to-text process by having the noise input being processed, the noise being decoded, and the decoded noise being output as text string.

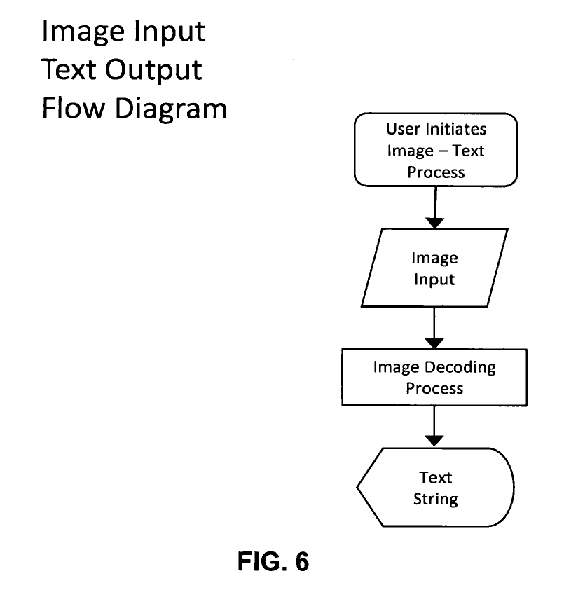

In yet another embodiment of the present invention, the visual interpretation mode, as illustrated in FIG. 6, uses the electronic computer system's camera to interpret the nearest discernable object or person and outputs the nature or name of the nearest discernable object or person through voice or text depending on the output format mode setting selected. To enable said functionality, the electronic computer system has a database of predetermined objects but also can be trained and/or previously configured to identify and define the name and/or nature of objects or people. For example, the training of the electronic computer system can take place with the audio command “add person” or “add object”. The electronic computer system's camera then identifies the distinct facial features of the nearest person or object and, thereafter, these distinct facial features are saved in the electronic computer system's memory. The electronic computer system's speakers may then ask for the name of nearest person or object and the user may respond with the name of the nearest person or object which is then associated to the collected facial information or physical characteristics. In the particular setting, the user initiates the image-to-text process by having the image input being processed, the image being decoded, and the decoded image being output as text string.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The invention claimed is:

1. A language interface method, comprising:
selecting, through an electronic computer system, a setting mode, the setting mode being selected from a group of input/output modes comprising language mode, noise interpretation mode or visual interpretation mode;
receiving, through the electronic computer system, input in the form of language, audio or of an image;
interpreting, through the electronic computer system, the input as written language, spoken language or an identifiable physical object image depending on the setting mode selected; and
producing, through the electronic computer system, an output depending on the setting mode selected.

2. The method of claim 1, wherein the language mode processes language as input in the form of voice via the electronic computer system's microphone or in the form of text from an image via the electronic computer system's camera, wherein the language mode allows the user to select an input language and/or input format or wherein the input language is automatically detected by the electronic computer system.

3. The method of claim 1, wherein the language mode outputs language in the form of text or voice in the electronic computer system's display or speakers and wherein the language mode allows the user to select an output language and/or output format.

4. The method of claim 2, wherein the language mode allows the electronic computer system to discern voices from 2 or more speakers and differentiate output from the 2 or more speakers.

5. The method of claim 4, wherein the voices from 2 or more speakers are discerned based on prior training of the electronic computer system, wherein the prior training of the electronic computer system involves identifying a specific speaker and identifying characteristics of the speaker's voice, and wherein output in the electronic computer system from 2 or more speakers are differentiated with different color text presented in the electronic computer system's display, if the language mode outputs language in the form of text, or differentiated with numbers, if the language mode outputs language in the form of voice.

6. The method of claim 1, wherein the noise interpretation mode processes audio as input, the audio input being analyzed and interpreted as common urban sounds by the electronic computer system, and outputs the analyzed and interpreted audio input in the form of text or voice.

7. The method of claim 1, wherein the visual interpretation mode processes image as input, the image input being interpreted as the nearest discernable object or person, and outputs the interpreted nearest discernable object or person through voice or text, wherein the nearest discernable object is interpreted based on predetermined objects stored on a database, wherein the nearest discernable object or person is interpreted based on prior training of the electronic computer system which identifies and defines the name of objects or people, wherein the electronic computer system identifies distinct features of the nearest person or object, saves the identified distinct features of the nearest person or object in the electronic computer system's memory to later retrieve distinct features of the nearest person or object to the user based on the output mode selected.

8. The method of claim 1, wherein the method is preferably employed by a deaf, hearing impaired, mute or visually impaired user.

9. A language interface system, comprising:
one or more processors;
a memory coupled to the one or more processors and which cause the one or more processors to:
select a setting mode, the setting mode being selected from a group of input/output modes comprising language mode, noise interpretation mode or visual interpretation mode;
receive input in the form of language, audio or of an image;
interpret the input as written language, spoken language or an identifiable physical object image depending on the setting mode selected; and
produce an output depending on the setting mode selected.

10. The system of claim 9, wherein the language mode processes language as input in the form of voice or in the form of text from an image, and wherein the language mode allows the user to select an input language and/or input format or wherein the input language is automatically detected.

11. The system of claim 9, wherein the language mode outputs language in the form of text or voice and wherein the language mode allows the user to select an output language and/or output format.

12. The system of claim 10, wherein the language mode allows the one or more processors to discern voices from 2 or more speakers and differentiate output from the 2 or more speakers.

13. The system of claim 12, wherein the voices from 2 or more speakers are discerned based on prior training of the system, wherein the prior training of the system involves identifying a specific speaker and identifying characteristics of the speaker's voice, and wherein output from 2 or more speakers are differentiated with different color text presented in the system's display, if the language mode outputs language in the form of text, or differentiated with numbers, if the language mode outputs language in the form of voice.

14. The system of claim 9, wherein the noise interpretation mode processes audio as input, the audio input being analyzed and interpreted as common urban sounds, and outputs the analyzed and interpreted audio input in the form of text or voice.

15. The system of claim 9, wherein the visual interpretation mode processes image as input, the image input being interpreted as the nearest discernable object or person, and outputs the interpreted nearest discernable object or person through voice or text, wherein the nearest discernable object is interpreted based on predetermined objects stored on a database, wherein the nearest discernable object or person is interpreted based on prior training of the system which identifies and defines the name of objects or people, and wherein the system identifies distinct features of the nearest person or object, saves the identified distinct features of the nearest person or object in the memory to later retrieve distinct features of the nearest person or object to the user based on the output mode selected.

16. The system of claim 9, wherein the system is preferably employed by a deaf, hearing impaired, mute or visually impaired user.

17. A non-transitory, tangible computer readable storage medium which causes an electronic computer system to act as a language interface, by a method comprising:
selecting, through the electronic computer system, a setting mode, the setting mode being selected from a group of input/output modes comprising language mode, noise interpretation mode or visual interpretation mode;
receiving, through the electronic computer system, input in the form of language, audio or of an image;
interpreting, through the electronic computer system, the input as written language, spoken language or an identifiable physical object image depending on the setting mode selected; and
producing, through the electronic computer system, an output depending on the setting mode selected.

18. The non-transitory, tangible computer readable storage medium of claim 17, wherein the language mode processes language as input in the form of voice via the electronic computer system's microphone or in the form of text from an image via the electronic computer system's camera, and wherein the language mode allows the user to select an input language and/or input format or wherein the input language is automatically detected by the electronic computer system.

19. The non-transitory, tangible computer readable storage medium of claim 17, wherein the language mode outputs language in the form of text or voice in the electronic computer system's display or speakers and wherein the language mode allows the user to select an output language and/or output format.

20. The non-transitory, tangible computer readable storage medium of claim 18, wherein the language mode allows the electronic computer system to discern voices from 2 or more speakers and differentiate output from the 2 or more speakers, wherein the voices from 2 or more speakers are discerned based on prior training of the electronic computer system, wherein the prior training of the electronic computer system involves identifying a specific speaker and identifying characteristics of the speaker's voice, and wherein output in the electronic computer system from 2 or more speakers are differentiated with different color text presented in the electronic computer system's display, if the language mode outputs language in the form of text, or differentiated with numbers, if the language mode outputs language in the form of voice.

21. The non-transitory, tangible computer readable storage medium of claim 17, wherein the noise interpretation mode processes audio as input, the audio input being analyzed and interpreted as common urban sounds by the electronic computer system, and outputs the analyzed and interpreted audio input in the form of text or voice.

22. The non-transitory, tangible computer readable medium of claim 17, wherein the visual interpretation mode processes image as input, the image input being interpreted as the nearest discernable object or person, and outputs the interpreted nearest discernable object or person through voice or text, wherein the nearest discernable object is interpreted based on predetermined objects stored on a database, wherein the nearest discernable object or person is interpreted based on prior training of the electronic computer system which identifies and defines the name of objects or people, wherein the electronic computer system identifies distinct features of the nearest person or object, saves the identified distinct features of the nearest person or object in the electronic computer system's memory to later retrieve distinct features of the nearest person or object to the user based on the output mode selected.

23. The non-transitory, tangible computer readable medium of claim 17, wherein the method is preferably employed by a deaf, hearing impaired, mute or visually impaired user.
